(19) United States
(12) Patent Application Publication
(10) Pub. No.: US 2005/0190445 A1
(43) Pub. Date: Sep. 1, 2005

(54) Wire grid polarizer

(76) Inventor: Yoshio Fukuzaki, Kawasaki-shi (JP)

Correspondence Address: NATH & ASSOCIATES, PLLC;Sixth Floor, 1030 15th Street, N.W., Washington, DC, 20005, US

(21) Appl. No.: 11/062,702

(22) Filed: Feb. 23, 2005

(30) Foreign Application Priority Data
Feb. 27, 2004 (JP) P2004-053221

(51) Int. Cl. G02B 5/30

(52) U.S. Cl. 359/486; 359/500

(57) ABSTRACT

To provide a wire grid polarizer used in an image display apparatus, in which even when the image display apparatus is of a small compact structure and provides high output of power from the light source, shape transformation of the glass substrate occurring due to generation of heat caused by light absorption in the wire grid is prevented and in which by efficient usage of light rays from the light source, high-quality images can be displayed by the image display device and power consumption is low. A wire grid 2 formed of metal in a fine comb shape is formed on a glass substrate 1 and antireflection coatings 3a and 3b are disposed respectively on the front surface part and the rear surface part of the wire grid 2 of the glass substrate 1.

### FIELD OF THE INVENTION

The present invention relates to a wire grid polarizer used as polarized light separating elements for a liquid crystal projector apparatus or the like.

### BACKGROUND OF THE INVENTION

Projection type image display apparatuses using reflective type liquid crystal spatial light modulating elements have been proposed in conventional technology. Such image display apparatuses comprise a light source, an optical system in which spatial light modulating elements are illuminated by light rays emitted from the light source and a light projection system that projects modulated light modulated by the spatial light modulating elements onto a screen.

Reflective type liquid crystal spatial light modulating elements are elements that reflect projected light rays, modulating the condition of polarization thereof for each pixel, in response to an externally supplied image signal.

In such a conventional image display apparatus, modulated light modulated by the spatial light modulating elements and unmodulated light injected into the spatial light modulating elements must be separated by polarized light separating elements such as a polarization beam splitter.

Moreover, a wire grid type polarization beam splitter, that is to say, a wire grid polarizer as that disclosed in U.S. Pat. No. 6,234,634, has been proposed to provide polarized light separating elements that are smaller and lighter than a polarization beam splitter. This wire grid polarizer comprises elements formed of a fine, comb shaped wire grid of a metal such as aluminum or tungsten or the like disposed on a glass substrate (barium fluoride (BaF₂), calcium fluoride substrate (CaF₂) or zinc selenium substrate). Light incident to the side on which this wire grid is formed undergoes polarized light separation. That is to say, in this wire grid polarizer parallel polarized light elements are reflected at the comb shaped wire while perpendicular elements are passed.

### SUMMARY OF THE INVENTION

The following problems arise when a wire grid polarizer as described above is used for a high output image display apparatus having substantial light output from the light source.

That is to say, as such wire grid polarizers separate polarized light by a plurality of fine metal wires heat arises due to light absorption occurring in these metal wires. When the metal from which these fine wires are formed is aluminum, due to the physical properties, approximately 10% of incident light energy is absorbed and converted into heat energy. There is concern that the form of the glass substrate on which the wire grid is formed may be changed as a result of such heat. If the shape of the glass substrate of a wire grid polarizer in an image display apparatus is altered the quality of images displayed deteriorates considerably as distortion and positional shift in the displayed image occurs.

In order to prevent such shape transformation due to heating of the glass substrate a cooling mechanism is required making the structure of such an image display apparatus large and complex. Further, the quantity of heat arising in the wire grid increases in proportion to light output from the light source of the image display apparatus, thus the size of the required cooling mechanism also increases.

Again, even where the light output from the light source of such an image display apparatus is not high, to achieve a small sized configuration for the apparatus more concentrated rays must be directed to the wire grid polarizer leading to an increase in energy applied per unit of area which causes concern of changes occurring in the shape of the glass substrate. In this instance, it becomes extremely difficult to install an effective cooling mechanism in order to achieve a small sized construction for the image display apparatus.

Moreover, light energy absorbed by the fine metal wire forming the wire grid cannot be released by the image display apparatus as light output, leading to a reduction in the efficiency with which light rays from the light source are utilized making it extremely difficult for the image display apparatus to be economical in terms of power i.e. having low power consumption.

The present invention is proposed as a means of solving the above described problems, being a wire grid polarizer which when used in an image display apparatus prevents the problem of shape change in the glass substrate occurring due to absorption of heat by the wire grid even while achieving a small sized apparatus construction with high output from the light source and enables high quality to images to be displayed by the image display apparatus. Moreover, the wire grid polarizer of this convention enables a low power consumption image display apparatus to be achieved in which light rays from the light source are used efficiently.

In order to solve the above described problems the wire grid polarizer of the present invention comprises a glass substrate and a wire grid of a metallic substance formed on one surface of the glass substrate, wherein the glass substrate has an antireflection film (coating) formed on the front surface part formed on the wire grid and on the rear surface part. The wire grid should be of a fine comb shaped form.

When this wire grid polarizer is used as polarized light separating elements in an image display apparatus using reflective type liquid crystal spatial light modulating elements the appearance of the ghosting phenomena in a displayed image can be suppressed, further, light illuminated from the light source can be utilized more efficiently.

Further, it is preferable for the glass substrate of the wire grid polarizer of the present invention to be formed of material the coefficient of linear thermal expansion of which is less than 6.0×10⁻⁷.

When this wire grid polarizer is used as polarized light separating elements in an image display apparatus using reflective type liquid crystal spatial light modulating elements, even as the wire grid absorbs light rays and generates heat, heat induced shape distortion of the glass substrate does not occur and positional shift and distortion in a displayed image does not arise.

The wire grid polarizer related to the present invention has an antireflection coating applied to the rear surface part of the glass substrate and to the front surface part on which is formed a wire grid, such that when this wire grid polarizer is used as polarized light separating elements in an image display apparatus using reflective type liquid crystal spatial light modulating elements the occurrence of the ghosting phenomena in displayed images can be suppressed and light illuminated from the light source can be used more efficiently.

Further, as the glass substrate is formed of a material having a coefficient of linear thermal expansion of below 6.0×10⁻⁷, when this wire grid polarizer is used as polarized light separating elements in an image display apparatus using reflective type liquid crystal spatial light modulating elements, even as the wire grid absorbs light rays and generates heat, heat induced shape distortion of the glass substrate does not occur and positional shift and distortion in a displayed image does not arise.

Again, in an image display apparatus using this wire grid polarizer, as thermal expansion in the glass substrate is not great, even if heat is generated in the wire grid, where there is only a small degree of internal stress occurring in the glass substrate and the photoelastic constant of the glass substrate is not small, distortion in the form of polarized light does not occur and color non-uniformnity in a displayed image or a deterioration in the contrast or non-uniformnity of brightness does not arise.

That is to say, the present invention provides a wire grid polarizer that when used in an image display apparatus, even when the image display apparatus is of a small compact structure and provides high output of power from the light source, enables shape transformation of the glass substrate occurring due to generation of heat caused by light absorption in the wire grid to be prevented, enables high-quality images to be displayed by the image display device and enables realization of low power consumption by efficient usage of light rays from the light source.

### BRIEF DESCRIPTION OF THE DRAWINGS

FIG. 1 provides a cross-sectional view showing the structure of a wire grid polarizer according to the present invention.

FIG. 2 is a side view showing a first configuration of an image display apparatus configured using the wire grid polarizer according to the present invention.

FIG. 3 is a side view showing a second configuration of an image display apparatus configured using the wire grid polarizer according to the present invention.

### DETAILED DESCRIPTION OF THE INVENTION

The embodiments of the image display apparatus according to the present invention will now be described in detail with reference to the drawings.

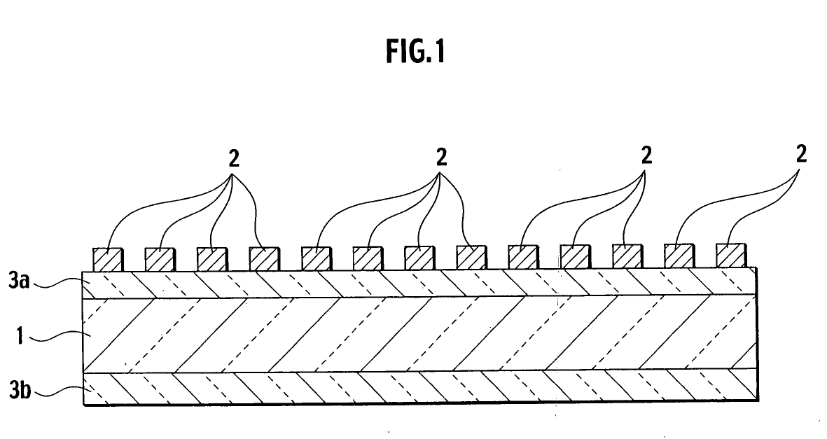

FIG. 1 provides a cross-sectional view showing the structure of a wire grid polarizer according to the present invention.

As shown in FIG. 1, this wire grid polarizer consists of elements wherein a comb shaped wire grid 2 of a metal such as aluminum or tungsten or the like is formed on a glass substrate 1.

This wire grid polarizer performs polarized light separation in respect of light incident to the surface on that side on which the wire grid 2 is formed. That is to say, this wire grid polarizer reflects polarization elements parallel to the comb shaped wire and passes elements orthogonal thereto. These properties of this wire grid can be used for a variety of purposes for polarization separation such as frequency separation using polarization or as a side band removal filter.

The wires of the wire grid are formed having a diameter of several μm to several tens μm and are spaced with an interval therebetween of between several tens to several hundreds μm.

In this wire grid polarizer the glass substrate 1 is comprised of transparent material in which the coefficient of linear thermal expansion a is below 6.0×10⁻⁷, not including lead oxide (PbO). Basically, quart, fused silica, Neoceram made by Nippon Electric Glass, Clearceram made by Ohara, ULE made by Coming, Vycol made by Corning or Zerodur by Schott can be used as material for this glass substrate 1.

Because a glass substrate made from any of these materials does not include lead oxide (PbO) any of those manufacturers can be selected enabling low-cost production.

The thickness of this glass substrate 1 is below 1.0 mm.

The antireflection coatings 3a and 3b are applied to the front surface part forming the wire grid 2 and the rear surface part of the glass substrate 1 respectively. These antireflection coatings 3a and 3b are formed such that when used in a wavelength region of for example 420 nm to 680 nm the absolute reflection ratio is below 0.5%.

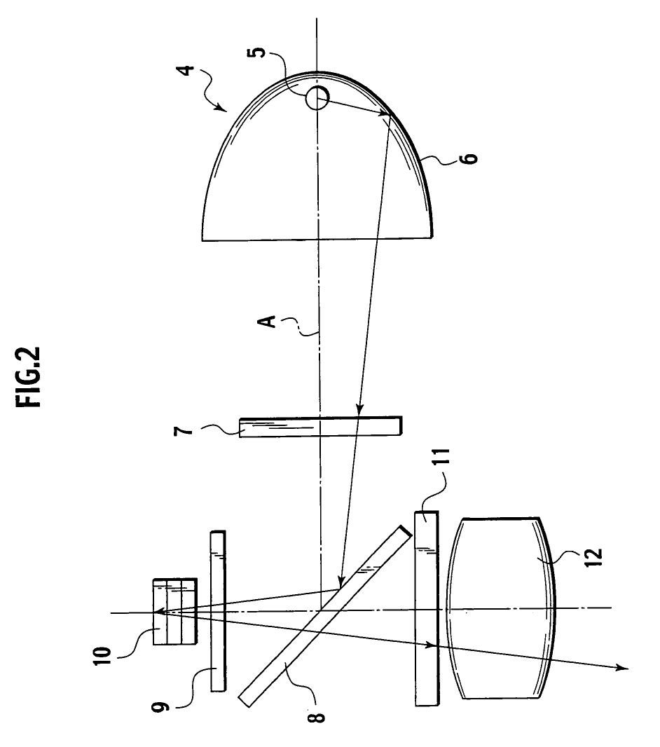

FIG. 2 is a side view showing a first configuration of an image display apparatus configured using the wire grid polarizer according to the present invention.

As shown in FIG. 2, an image display apparatus configured using the wire grid polarizer according to the present invention has a light source lamp 4. This light source lamp 4 is constructed comprising a light source 5 and a reflector 6 that reflects light emitted from the light source 5 in the direction of the optical axis A. A lamp that emits white light such as a high-pressure mercury lamp or a metal halide lamp or the like can be used for this light source 5. The reflector 6 has a reflective surface that is an ellipsoid that rotates around the optical axis A, such that light emitted from the light source 5 is reflected at the reflective surface and omitted as converged light rays.

Light emitted from the light source 4 is reflected at the filter 6 and the intensity of illumination is rendered uniform as the light passes an integrator not shown in the drawing. Passing a pre-polarizer 7 the light is organized into S polarized light and P polarized light. In addition to a polarization filter, what is known as a PS combiner in which a plurality of polarization beam splitters are arranged configured in parallel can be used as this pre-polarizer 7.

Light that has passed this pre-polarizer 7 is incident to the wire grid polarizer 8 of the present invention. This wire grid polarizer 8 has the front surface thereof on which is formed a wire grid disposed facing the pre-polarizer 7 side and is disposed such that incident light rays from the pre-polarizer 7 over the optical axis A enter at an angle of incidence of 45°. In respect of this wire grid polarizer 8, the direction of polarization of incident light is a direction parallel to the wires forming the wire grid. Accordingly, this light is reflected at the wire grid, passes a phase plate 9 and enters reflective type liquid crystal spatial light modulating elements 10.

The phase plate 9 is for adjusting the direction of polarization of the light. The reflective type liquid crystal spatial light modulating elements 10 modulate the direction of polarization of the light in response to an image signal supplied from an external source and reflect the light.

This modulated light, the direction of polarization of which has been modulated at the reflective type liquid crystal spatial light modulating elements 10 passes the phase plate 9 and returns to the wire grid polarizer 8. The direction of polarization of the modulated light modulated at the reflective type liquid crystal spatial light modulating elements 10 is of a direction orthogonal to the wires forming the wire grid of the wire grid polarizer 8, accordingly, this modulated light passes the wire grid, passes the glass substrate of the wire grid polarizer 8, passes a polarized light analyzer in 11 and enters a projection lens 12. The polarized light analyzer 11 is a filter for removing redundant polarized light elements.

The projection lens 12 projects the modulated light thus input onto a screen not shown in the drawing, forming an image which is displayed on that screen.

In this image display apparatus, as the coefficient of linear thermal expansion of the glass substrate of the wire grid polarizer 8 is sufficiently small, even though the wire grid of the wire grid polarizer 8 absorbs light rays thereby generating heat, shape distortion of the glass substrate does not occur and positional shift and distortion of a displayed image does not arise. Further, as there is only a small degree of thermal expansion of the glass substrate in this image display apparatus, even if heat is generated in the wire grid, where only a small degree of internal stress arises in the glass substrate and the photoelastic constant of the glass substrate is not small, distortion in the form of polarized light does not occur and color non-uniformity in the displayed image or a deterioration in contrast does not arise.

Moreover, as the glass substrate of the wire grid polarizer 8 for the image display apparatus has a thickness of below 1.0 mm, the occurrence of astigmatism in light rays passing this glass substrate is small enabling correction for astigmatism affecting the projection lens to be insubstantial making design of the projection lens more simple.

As an antireflection coating is applied to both surfaces of the glass substrate of the wire grid polarizer 8 of this image display apparatus, Fresnel reflection loss is insubstantial enabling display of images having a high degree of brightness and further, light illuminated from the light source can be more effectively utilized. If an antireflection coating is not applied to the glass substrate Fresnel reflection loss of approximately 4% will occur. As a result of the application of this antireflection coating, the rate of reflection at the surface of the glass substrate is below 0.5% such that the occurrence of the ghosting phenomena in displayed images can be suppressed.

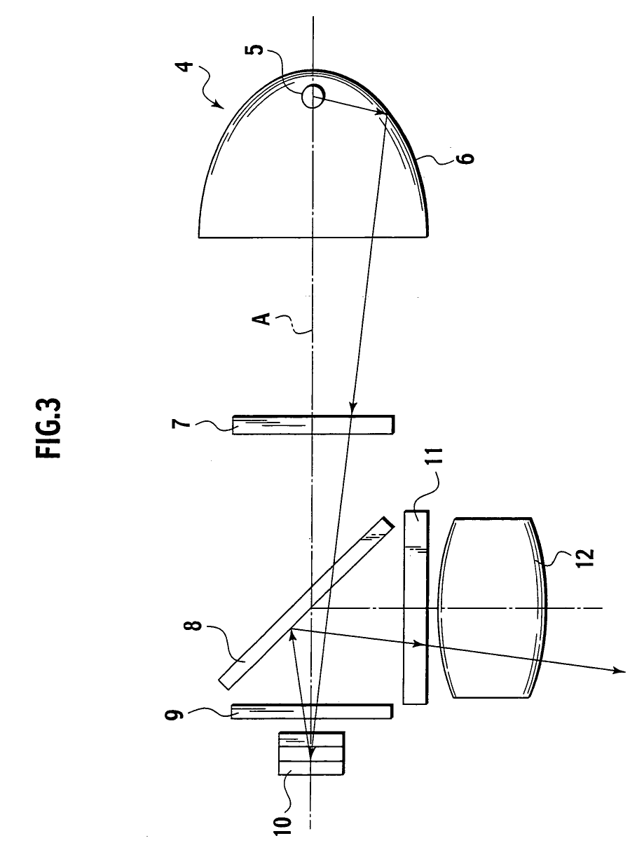

FIG. 3 is a side view showing a second configuration of an image display apparatus configured using the wire grid polarizer according to the present invention.

As shown in FIG. 3, this image display apparatus configured using the wire grid polarizer related to the present invention is configured such that light illuminated from a light source lamp 4 passes the wire grid polarizer 8 and reaches the reflective type liquid crystal spatial light modulating elements 10.

That is to say, illuminating light emitted from the light source lamp 4 having a light source 5 and reflector 6 is arranged into S polarized light or P polarized light by a pre-polarizer 7 that passes only S polarized light or P polarized light and is injected into the wire grid polarizer 8 of this invention. This wire grid polarizer 8 has the rear surface part having no wire grid formed thereon facing the pre-polarizer 7 side and is disposed such that that incident light rays from the pre-polarizer 7 over the optical axis A enter at an angle of incidence of 45°.

In respect of this wire grid polarizer 8, the direction of polarization of incident light is a direction orthogonal to the wires forming the wire grid. Accordingly, this light passes the wire grid and the glass substrate of the wire grid polarizer 8 and travels via a phase plate 9 before entering the reflective type liquid crystal spatial light modulating elements 10.

The reflective type liquid crystal spatial light modulating elements 10 modulate the direction of polarization of the light in response to an image signal supplied from an external source and reflect the light. This modulated light, the direction of the polarization of which is modulated by the reflective liquid crystal spatial light modulating elements 10 passes via the phase plate 9 and returns to the wire grid polarizer 8.

The direction of polarization of the modulated light modulated at the reflective type liquid crystal spatial light modulating elements 10 is of a direction parallel to the wires forming the wire grid of the wire grid polarizer 8, accordingly, this modulated light is reflected at the wire grid, passes a polarized light analyzer 11 and enters a projection lens 12. The projection lens 12 projects the modulated light thus input onto a screen not shown in the drawing, forming an image which is displayed on that screen.

In this image display apparatus, as the coefficient of linear thermal expansion of the glass substrate of the wire grid polarizer 8 is sufficiently small, even though the wire grid of the wire grid polarizer 8 absorbs light rays thereby generating heat, shape distortion of the glass substrate does not occur and positional shift and distortion of a displayed image does not arise. Further, as there is only a small degree of thermal expansion of the glass substrate in this image display apparatus, even if heat is generated in the wire grid, where only a small degree of internal stress arises in the glass substrate and the photoelastic constant of the glass substrate is not small, distortion in the form of polarized light does not occur and color non-uniformity in the displayed image or a deterioration in contrast does not arise.

As an antireflection coating is applied to both surfaces of the glass substrate of the wire grid polarizer 8 of the image display apparatus, Fresnel reflection loss is insubstantial enabling display of images having a high degree of brightness and further, light illuminated from the light source can be more effectively utilized.

Again, as the rate of reflection at the surface of the glass substrate is below 0.5% due to the existence of an antireflection coating applied to the glass substrate, the appearance of the ghosting phenomena in a displayed image can be suppressed. It is preferable, especially in the case where the contrast of a displayed image is set above 1000:1 for the rate of reflection at the surface of the glass substrate to be below 0.1% and in the case where the contrast of the displayed image is set above 2000:1 for the rate of reflection at the surface of the glass substrate to be below 0.05%.

As shown in FIG. 2, as a result, the configuration shown in FIG. 3 in which light from the light source lamp 4 passes the wire grid polarizer 8 and reaches the reflective type liquid crystal spatial light modulating elements 10 is preferable to the configuration shown in FIG. 2 in which light from the light source lamp 4 is reflected at the wire grid polarizer 8 and reaches the reflective type liquid. crystal spatial light modulating elements 10.

1. A wire grid polarizer comprising:
a glass substrate;
a wire grid of metal formed on one side of the glass substrate; and
an antireflection film formed on a front surface part formed of the wire grid of the glass substrate and on a rear surface part of the glass substrate.

2. The wire grid polarizer according to claim 1, wherein the glass substrate is formed of a material having a coefficient of linear thermal expansion below 6.0×10⁻⁷.

3. The wire grid polarizer according to claim 1, wherein the thickness of this glass substrate is below 1.0 mm.

4. The wire grid polarizer according to claim 1, wherein the absolute reflection ratio of the antireflection film for the wavelength region of 420 nm to 680 nm is below 0.5%.

5. A wire grid polarizer comprising:
a glass substrate;
an antireflection film formed on a front surface part and a rear surface part of the glass substrate; and
a wire grid of metal formed on the antireflection film on the front surface part.

6. The wire grid polarizer according to claim 5, wherein the glass substrate is formed of a material having a coefficient of linear thermal expansion below 6.0×10⁻⁷.

7. The wire grid polarizer according to claim 5, wherein the thickness of this glass substrate is below 1.0 mm.

8. The wire grid polarizer according to claim 5, wherein the absolute reflection ratio of the antireflection film for the wavelength region of 420 nm to 680 nm is below 0.5%.
